(19) United States
(12) Patent Application Publication
(10) Pub. No.: US 2009/0047652 A1
(43) Pub. Date: Feb. 19, 2009

(54) Aroma Sensitive Building Blocks and Methods of Teaching Fragrance Recognition Using an Olfactory Alphabet

(76) Inventor: Donald Spector, New York, NY (US)

Correspondence Address: COLLARD & ROE, P.C., 1077 NORTHERN BOULEVARD, ROSLYN, NY, 11576, US

(21) Appl. No.: 12/046,739

(22) Filed: Mar. 12, 2008

Related U.S. Application Data
(60) Provisional application No. 60/956,696, filed on Aug. 18, 2007.
(60) Provisional application No. 60/982,875, filed on Oct. 26, 2007.

(51) Int. Cl. G09B 19/00

(52) U.S. Cl. 434/403

(57) ABSTRACT

Olfactory teaching apparatus and methods for teaching a person to recognize fragrances is disclosed. The teaching apparatus comprises a housing, a fragrance and initially unreadable indicia describing the fragrance.

### CROSS-REFERENCE TO RELATED APPLICATIONS

This application claims the benefit of priority under 35 U.S.C. § 119(e) to U.S. Provisional Application Ser. Nos. 60/956,696, filed Aug. 18, 2007 and 60/982,875, filed Oct. 26, 2007, the disclosures of which are incorporated herein by reference thereto.

### FIELD OF THE INVENTION

This invention relates to the field of Aroma and Fragrance training, directed to children, but can also be used in adult games and training.

### BACKGROUND OF THE DISCLOSURE

One of the first developed areas of the brain is the olfactory sense. This is one of the most primitive senses, since it was used to track prey and identify food. Bad smells often denote danger, and in societies which used a lot of spices, ivory sticks were devised so that they changed color to show danger.

However, there is very little training of the sense of smell. Over two decades ago I had a game which tested the ability of children to place things according to the sense of smell. It was immediately apparent that they failed almost every time. Many children confuse Cherry with Strawberry because they were both red. In fact, many adults still confuse fragrance/flavors with color, since almost all early learning is done from written or visual materials.

Fragrances are defined in groupings. Traditionally, these groupings have been hit and miss with popular scents and associations with the sense of sight. In this case, the fragrance of cherry is often associated with strawberry, not from a fragrance point of view, merely because they are both red.

Therefore, there is a need to teach people to recognize fragrances using primarily olfactory sensory input.

### SUMMARY OF THE INVENTION

The various aspects of the invention can be used for many purposes. For example, a person can be taught to recognize smells associated with a specific job, or hazard. Studies have shown that the general IQ of children is increased with sensory input during early childhood development. Aspects of the invention can be used to provide developmental stimulation for a child. Other uses for aspects of the invention are contemplated and should not be considered outside the scope of the invention.

The kits of some aspects of the invention can be organized into a fragrance alphabet. For example, fragrance kits can be assembled based on categories, such as floral, fruit, mold-based, burnt smells, oil-based smells, etc. This would allow for specific kits to be developed depending on the desired application.

According to one or more aspects of the invention, an olfactory teaching apparatus is disclosed. The apparatus comprises a housing, a substance retaining a fragrance, a fragrance and indicia identifying the fragrance. The indicia is initially unreadable, or concealed, so that the person using the olfactory building block does not accidentally become aware of the identity of the fragrance.

Other aspects of the invention are directed to a kit for teaching fragrance recognition. The kit may include multiple housings, each having a different fragrance. The kit may also include a separate device or instructions allowing for the decoding of the identity of the fragrance. The kit can further include an instruction manual which teaches, for example, groupings of fragrances which are organized to help people remember fragrances.

Additional aspects of the invention are directed to methods of teaching a person to recognize fragrances. Aspects of the methods comprise smelling at least one housing containing a fragrance and attempting to identify the fragrance. Initially unreadable indicia can then be consulted to verify the identification of the fragrance.

Other aspects of the invention are directed toward methods of teaching a person. The method includes smelling at least one housing containing a fragrance, where the housing has initially unreadable indicia on the outside which identifies the fragrance. The user attempts to identify the fragrance and then uses the indicia to verify the accuracy of the attempted identification.

The user may connect the housing to a separate electronic device. The separate electronic device may read the identity of the fragrance and communicate the same to the user. The electronic device can communicate by any available means, including, but not limited to, displaying a picture representative of the fragrance, displaying a word or series of words describing the fragrance, speaking the identity of the fragrance using a voice synthesizer, etc. Thus, the user learns the correct identification of the fragrance from looking at or listening to the electronic device.

### BRIEF DESCRIPTION OF THE DRAWINGS

The teachings of the present invention can be readily understood by considering the following detailed description in conjunction with the accompanying drawings, in which:

FIG. 1 shows an aspect of the invention; and

FIG. 2 shows an aspect of the invention having pinouts indicia and a separate device to determine the identity of the fragrance.

### DETAILED DESCRIPTION

Before describing several exemplary embodiments of the invention, it is to be understood that the invention is not limited to the details of construction or process steps set forth in the following description. The invention is capable of other embodiments and of being practiced or being carried out in various ways.

As used in this specification and the appended claims, the singular forms “a”, “an” and “the” include plural referents unless the context clearly indicates otherwise. Thus, for example, reference to “a fragrance” includes a mixture of two or more fragrances, and the like.

Aspects of the present invention include Sensory Building Blocks. These blocks might be fragrance resistant plastic blocks with small holes in them so that a fragrance piece of plastic is inside. The pieces may be made of such a size that they would not represent a choking hazard. The blocks themselves could be fragrances or there could be a large variety of materials inside. The blocks may also have pictures of the products (or situations) that the fragrance is derived from. The blocks may be stacked or combined in a variety of ways. They may also have names written on them or have various other information contained as raised letters, or even scan-able material. There is virtually no limitation to other material that can be communicated.

On the most elementary level, basic fragrances such as Strawberry, Cherry, Orange, Banana, etc. can constitute the simplest type of block. These blocks can escalate into various types of flavors used in cooking, such as basil, dill, sage, etc. They can also represent basic smells such as dirt, burning rubber, electrical fire, etc.

A child can play a version of “peek-a-boo” with a parent in which he or she has to guess the block with their eyes closed. This is one of the easiest, earliest forms of fragrance training. Later on, these games can be extended to groupings. These groupings themselves have educational value in that they define groups such as fruit, vegetables, etc. Even older people can learn ingredients used in cooking by learning the smells of various ingredients. Spoiled food flavors can be added for amusement or learning.

In its more sophisticated form, these blocks can be combined to form a game of what might have happened, by combining the smell of alcohol, new car, burning rubber and ashes. We might hypothesize what happened in that case.

The sense of smell can be evolved to a very fine degree with perfumers, like great wine experts, developing this sense to a highly elevated degree.

A series of fragrances that represents a base of perception may be defined. These fragrances from plants, animals, organisms, waste products, manufacturing processes, etc. They may be put into various categories and defined into organized groups. Game play can be designed around the fundamental “alphabet” that is used to represent categories, rather than fit existing popular scents into a game.

According to one or more aspects of the invention, an olfactory teaching apparatus is disclosed. The apparatus is comprised of a housing, a substance retaining a fragrance, a fragrance and indicia identifying the fragrance. The indicia is concealed so that the person using the olfactory building block does not accidentally become aware of the identity of the fragrance.

In various aspects of the invention, the substance retaining the fragrance may be any substance which is capable of retaining a fragrance. Non-limiting examples of appropriate substances may be a solid, liquid, gas, gel, ointment, paint, or some other type of coating. Other aspects of the invention employ more than one different type of substance.

In other embodiments of the invention, the substances adapted to retain the fragrance is located within the housing. This can be done, for example, to prevent the person from coming into direct contact with the substance, or to increase the useful life of the substance. In some aspects of the invention, the housing is partially permeable to the fragrance. For example, the housing can be made of a semi-permeable material which allows the fragrance to diffuse from within the housing, or the housing may have ventilation holes which can allow the fragrance to pass through. Other mechanisms for making the housing at least partially permeable to the fragrance are also within the scope of the invention.

Various aspects of the invention include indicia identifying the fragrance. The indicia is initially unreadable so that the person smelling the fragrance does not inadvertently become aware of the identity of the fragrance. The term “unreadable” as used in this specification and the pending claims has an expanded meaning. “Uneadable” means that the indicia is either concealed, encoded, or of an unknown language. There are many ways to make the indicia unreadable, depending on the circumstances of use. Any means of making the fragrance identity less obvious, encoded or unseen by the person smelling the fragrance falls within the scope of the use of the term “unreadable”. For example, the indicia can be hidden beneath the housing or beneath a flap on the housing.

Where the intended user is of an age where literacy is unlikely, the indicia could simply be a word. Since the user cannot read the word, it is literally unreadable and the indicia has effectively concealed the identity of the fragrance from the smeller. The parent, adult or literate child who may be working with the user can relay the identity of the fragrance at the appropriate time.

The indicia can be encoded, such that reference to a separate device or listing is necessary to decode the identity. For example, the indicia may be a series of numbers or symbols. The user may then have to consult a separate list to translate the series of numbers or symbols into the identity of the fragrance.

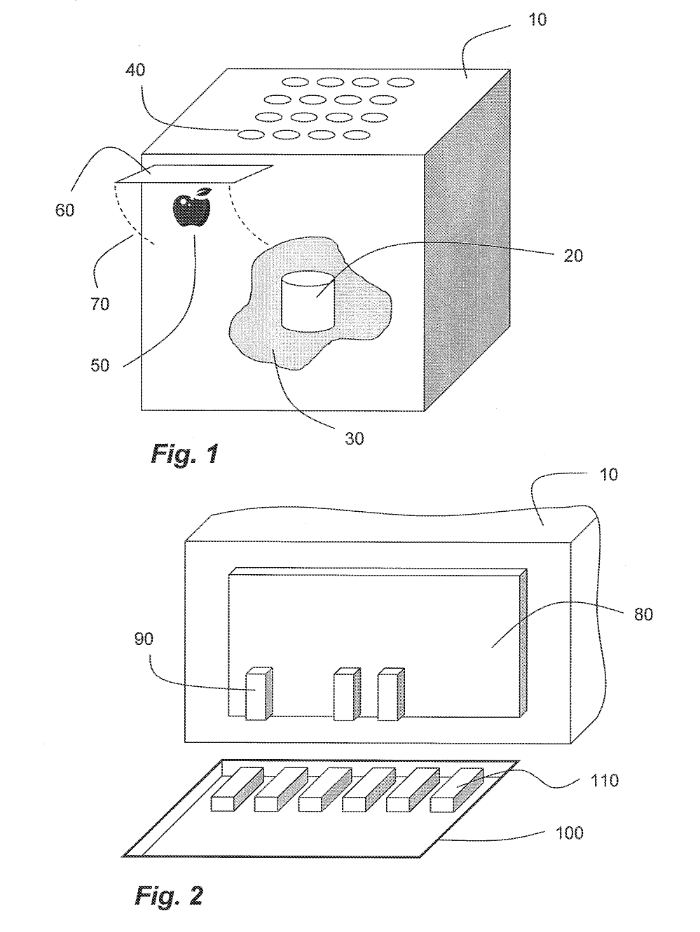

With reference to FIG. 1, a housing 10 is shaped like a cube, but can be any shape, as desired. A substance 20 adapted to hold a fragrance is enclosed within the housing 10. The substance 20 is viewed through an imaginary hole 30 in the housing 10. The fragrance (not shown) can be smelled through the housing 10 through the vent holes 40. Indicia 50 which describes the fragrance, here a picture of an apple, is initially concealed beneath a flap 60. The flap 60 is lifted along route 70 from adjacent the housing 10, where it covers indicia 50, to a position in which indicia 50 can be seen. Therefore, the indicia is not initially readable without manipulation of the flap 60.

The indicia of detailed embodiments of the invention can be concealed as a pinout which can be understood and interpreted by a separate device. For example, there could be electronic interface which can be connected to a computer or electronic device. The computer or electronic device can then be used to “read” the identity of the fragrance and present. Non-limiting examples of interfaces include serial, parallel, USB, IEEE-1394 (Firewire), wireless devices, etc.

The pinouts of other aspects are non-electrical in nature. They can be in the form of a series of bumps or detents, which can activate a series of matching bumps or detents in a separate device. The separate device can then “read” the identity of the fragrance. To detail this aspect, the following example is presented. The pinout may be represented by a series of, say, six potential nodes. Each node may be either flat or a protrusion, like observed in Braille writing. For a six node device, there would be a potential to distinguish up to 64 fragrances as each node can be either on or off. Where eight nodes are used, there could be up to 256 distinct fragrances identified. When the housing having this type of indicia is placed into a cradle, the protrusions depress switches in the cradle. The combination of switches depressed would be readable by the cradle device, which can then be communicated to the user.

With reference to FIG. 2, housing 10 (only a portion of which is shown) has a protuberance 80 with pinouts 90. Protuberance 80 fits into reader 100. Internal magnets, or other mechanism, can be used to ensure that the protuberance 80 remains seated with the reader 100. When protuberance 80 is seated within reader 100, pinouts 90 press the correlated keys 110. In this example, the first, third and fourth keys 110 would be pressed. There are six keys shown in FIG. 2, which results in 64 different key combinations. The invention is not limited to only 64 different key combinations or six keys. As many combinations as is desired can be made using more or less keys and pinouts.

Non-limiting examples of suitable indicia include text, images, symbols, codes, electronic connections (including computer interface connections) and physical connections like the nodes described. Other means can be used to conceal the identity of the fragrance without deviating from the spirit and scope of the appended claims.

Various aspects can have different shaped housings. For example, the housing can be generally spherical, cubic, rectangular, elliptical, pyramidal, etc. The surface of the housing can be either smooth or textured. The surface can have textured designs, which may or may not be functional in nature. Other aspects of the invention allow for the housings to be shaped such that they can be easily stacked.

Further aspects of the invention are directed to a kit for teaching fragrance recognition. The kit may include multiple housing, each having a different fragrance. The kit may also include separate devices or instructions allowing for the decoding of the identity of the fragrance

Additional aspects of the invention are directed to methods of teaching a person to recognize fragrances. Aspects of the methods comprise smelling at least one housing containing a fragrance and attempting to identify the fragrance. The initially unreadable indicia can then be consulted to verify the identification of the fragrance.

The various aspects of the invention can be used for many purposes. For example, a person can be taught to recognize smells associated with a specific job, or hazard. Studies have shown that the general IQ of children is increased with sensory input during early childhood development. Aspects of the invention can be used to provide developmental stimulation for a child. Other uses for aspects of the invention are contemplated and should not be considered outside the scope of the invention.

The kits of some aspects of the invention can be organized into a fragrance alphabet. For example, fragrance kits can be assembled based on categories, such as floral, fruit, mold-based, burnt smells, oil-based smells, etc. This would allow for specific kits to be developed depending on the desired application.

Another aspect of the teaching kit includes an instruction manual. The manual may include groupings of fragrances that will be taught as part of a system to “organize” how people remember fragrances. The manual may also include notes on the fragrances.

Other aspects of the invention are directed toward methods of teaching a person. The method includes smelling at least one housing containing a fragrance, where the housing has initially unreadable indicia on the outside which identifies the fragrance. The user attempts to identify the fragrance and then uses the indicia to verify the accuracy of the attempted identification.

The user may connect the housing to a separate electronic device. The separate electronic device reads the identity of the fragrance and communicates the identity of the fragrance to the user. The electronic device can communicate by any available means, including, but not limited to, displaying a picture representative of the fragrance, displaying a word or series of words describing the fragrance, speaking the identity of the fragrance using a voice synthesizer, etc. Thus, the user learns the correct identification of the fragrance from looking at or listening to the electronic device.

Although various embodiments and aspects which incorporate the teachings of the present invention have been shown and described in detail herein, those skilled in the art can readily devise many other varied embodiments and aspects that still incorporate these teachings. Accordingly, the described embodiments and aspects are to be considered in all respects only as illustrative and not restrictive. Therefore, it is to be understood that nothing shall be construed as a limitation of the present invention, other than the structure recited in the appended claims.

What is claimed is:

1. An olfactory teaching apparatus for use by a person, comprising:
a housing;
a fragrance;
a substance adapted to retain the fragrance; and
indicia identifying the fragrance, wherein the indicia is initially unreadable by the person.

2. The olfactory teaching apparatus of claim 1, wherein the substance adapted to retain a fragrance is located within the housing.

3. The olfactory teaching apparatus of claim 1, wherein the substance adapted to retain a fragrance is selected from the group consisting of solids, gels and gases.

4. The olfactory teaching apparatus of claim 2, wherein the housing is at least partially permeable to the fragrance.

5. The olfactory teaching apparatus of claim 1, wherein the housing is in the shape of a cube.

6. The olfactory teaching apparatus of claim 1, wherein the indicia comprises text.

7. The olfactory teaching apparatus of claim 1, wherein the indicia comprises an image.

8. The olfactory teaching apparatus of claim 1, wherein the indicia is covered.

9. The olfactory teaching apparatus of claim 1, wherein the indicia comprises pinouts adapted to be interpreted and revealed by an electronic device.

10. An olfactory teaching apparatus kit for use by a person, comprising a plurality of housings, each housing comprising:
a fragrance;
a substance adapted to retain the fragrance; and
indicia identifying the fragrance, wherein the indicia is initially unreadable by the person.

11. The olfactory teaching apparatus kit of claim 10, wherein each of the plurality of housings are adapted to be stacked or attached to each other.

12. The olfactory teaching apparatus kit of claim 10, wherein the indicia comprises pinouts adapted to be read by an electronic device.

13. The olfactory teaching apparatus kit of claim 12, further comprising an electronic device adapted to interpret the pinouts and communicate the identity of the fragrance audibly and/or visually.

14. The olfactory teaching apparatus kit of claim 10, further comprising an instruction manual.

15. A method of teaching a person to smell comprising:
smelling at least one housing containing a fragrance, the housing having an inside, an outside and initially unreadable indicia on the outside which identifies the fragrance;
attempting to identify the fragrance; and
using the indicia to verify the accuracy of the attempt to identify.

16. The method of claim 15, wherein the fragrance is on a substance adapted to retain the fragrance.

17. The method of claim 16, wherein the substances adapted to retain the fragrance is located inside the housing and the housing is at least partially permeable to the fragrance.

18. The method of claim 15, wherein the indicia comprises pinouts adapted to be read by an electronic device.

19. The method of claim 18, further comprising:
placing the housing within an electronic device, the electronic device being able to read the pinouts on the housing and communicate the identity of the fragrance audibly and/or visually; and
learning the correct identification of the fragrance by listening to and/or looking at the electronic device.
